(19) United States
(12) Patent Application Publication
(10) Pub. No.: US 2016/0164871 A1
(43) Pub. Date: Jun. 9, 2016

(54) FAIL-SAFE DISTRIBUTED ACCESS CONTROL SYSTEM

(71) Applicant: KABA AG, Wetzikon (CH)

(72) Inventors: David Basin, Rüschlikon (CH); Srdjan Marinovic, Zürich (CH); Mohammad Torabi Dashti, Zürich (CH); Peter Tsankov, Zürich (CH)

(21) Appl. No.: 14/906,038

(22) PCT Filed: Jul. 16, 2014
(86) PCT No.: PCT/CH2014/000110

§ 371 Date: Jan. 19, 2016

(30) Foreign Application Priority Data
Jul. 22, 2013 (CH) 1298/13

(51) Int. Cl. H04L 29/06

(52) U.S. Cl. CPC H04L 63/10; H04L 63/08; H04L 63/14

(57) ABSTRACT

A distributed system includes two or more components, where at least one of the components is a Policy Decision Point (PDP). The PDP is capable of requesting information from another component of the distributed system, and the PDP is capable of executing an authorization process based on one or more policies defined in a policy language. The policy language includes a communicate command, an execution of which causes the PDP to request information from another component in the distributed system. The policy language also includes a fail operator, which defines handling of failures of the communicate command. An analysis tool for analyzing a result of an authorization process in a Policy Decision Point is also described.

### BACKGROUND OF THE INVENTION

1. Field of the Invention

The invention relates to the field of distributed systems including two or more components, where at least one of the components is a Policy Decision Point (PDP). The PDP is capable of requesting information from another component of the distributed system, and the PDP is capable of executing an authorization process based on one or more policies defined in a policy language. The invention also relates to an analysis tool for analyzing a result of an authorization process in a PDP. The invention relates to a distributed system and an analysis tool.

2. Field of the Invention

Distributed systems having a PDP capable of executing an authorization process are widely used in different technical fields. For example, a computer network is a distributed system including separate computers (i.e. components). The computer network may include one computer that is a PDP. The PDP is capable of authorizing a specific user to access data stored in a second component of the distributed system. The policies define the access rights of the specific user. These policies are usually stored in the PDP. Alternatively, they may be stored in a third component of the distributed system and retrieved by the PDP at each authorization process. According to the polices, the PDP either authorizes the request of the specific user and grants access to the data the user is asking for, or the PDP does not authorize the specific user and denies access to the data the user is asking for. In other words, the specific user asks in a first step a PDP to grant access to data. In a second step, the PDP retrieves policies from its own data storage or alternatively from the third component of the distributed system. And in a third step, the PDP grants the specific user access to the requested data stored in the second component or denies the access—based on the result of the policies.

Another example of a distributed system is a physical access control system, such as an access control system for a sports event place, a hotel, a facility or a complex building. A physical access control system can also control objects, for example by controlling access to a package stored in a storage compartment.

In the example of a physical access control system for a sports event, for example, this distributed system includes components such as a central storage memory with all information about access rights and physical gates which are PDPs. The gates include reading modules for reading entrance tickets. To enter the sports event place, a visitor presents an entrance ticket to the reading module of the gate. The gate then contacts the central storage memory to verify if the ticket is valid according to the policies stored in the central storage memory. According to the result of the validity check i.e. as a result of the policies, the gate grants the visitor access to the sports event place or denies the access. Such a distributed system is, for example, capable of preventing two visitors to enter the sports event place with the same entrance ticket by including a policy that each ticket can only be granted access once and storing information about the tickets that have been authorized already.

Disadvantages of such distributed systems are a large number of requests to the component that stores the policies. A large number of requests can degrade the performance of the distributed system and slow down authorization processes. The distributed system can be impaired or even stall if communication with the component storing the policies is of low quality or is blocked. Communication of low quality or blocked communication can also lead to undesired grants and denies of the authorization process, i.e. granting instead of denying access and vice versa, for example if an update on authorization information did not reach the PDP in time. For the reasons mentioned before, the distributed system of the state of the art can be attacked and manipulated. As an example, a malicious subject can exploit undesired grants or denies by manipulating communication channels between its components.

The state-of-the-art distributed systems usually feature a firmware which includes at least a part of the needed policies. The firmware of a component is therefore extensive. The firmware of a component features a large size and a high complexity. A distributed system including components with complex firmware is prone to logical inconsistencies and/or programming errors with regard to the functioning of the component and/or of the entire distributed system. Such distributed systems or their components are difficult to set up, to test and/or to install. Such distributed systems or their components are also difficult to maintain, to repair and/or to replace. Such distributed systems or its components are also difficult to update and/or to modify. Enlarging, updating, customizing or adapting such distributed systems or their components is tedious and time consuming.

Testing a component of a distributed system of the state of the art is usually done by setting up and testing the distributed system in parts or completely in its final configuration. Such testing is time consuming, tedious and/or work intensive. Testing is often done on the spot (i.e. on an installed distributed system in its final configuration and at its final location), which is disadvantageous for different reasons. For example, testing the distributed system after installing it prolongs the installation time and results in a prolonged unavailability of the distributed system. Errors are unexpected behavior, undesired behavior and/or malfunctions of the distributed system. Finding, determining and/or correcting the errors is difficult and time consuming, especially if testing is done on the spot. Also a modification of the components and/or a modification of the firmware of the components is in most cases difficult to be done on the spot. This applies even more for tests done for the first time/first iteration.

Furthermore, the state-of-the-art distributed systems cannot be analytically checked for undesired grants and/or undesired denies due to low quality and/or blocked communication. In other words, one can neither pose nor answer analysis questions pertaining to the result of an authorization process when communication between the components in the distributed system is impaired and/or blocked. Such undesired grants and denies often require a specific sequence of failure events to occur in the distributed system. Therefore, the undesired grants and denies are often missed by testing of the distributed system and furthermore they can remain undetected for a long time during the life-cycle of the distributed system. Such undesired grants and denies can be dangerous because they can be exploited by an attacker who can intentionally trigger the sequence of failures by disrupting communication channels.

### SUMMARY OF THE INVENTION

It is therefore an object of the invention to create a distributed system and an analysis tool of the type mentioned initially, which overcomes at least partially at least one of the disadvantages mentioned above.

The distributed system includes two or more components, where at least one of the components is a Policy Decision Point (PDP). The PDP is capable of requesting information from another component of the distributed system, and the PDP is capable of executing an authorization process based on one or more policies defined in a policy language. The policy language includes a communicate command. An execution of the communicate command causes the PDP to request information from another component of the distributed system. The policy language also includes a fail operator, which defines handling of failures of the communicate command.

A component of the distributed system is an entity capable of communicating with other components of the distributed system. A component includes software and/or hardware.

A policy defines an authorization process. Evaluating a policy against a request results in an outcome of Boolean type: either authorization is granted or denied. A policy can, for example, be defined using a matrix, a list of access rights, or a set of rules.

A policy language is a language with defined syntax (form respectively structure) and defined semantics (meaning). The syntax defines how a policy is formulated in the policy language, and the semantics defines how the policy is evaluated against a request, i.e. the semantics define the authorization process.

The communicate command, which is comprised by the policy language, causes a PDP to request information from another component of the distributed system if the communicate command is executed. The communicate command can include an identification of the component from which an information is to be requested (i.e. the component of the distributed system which is to be addressed), information about a type, a form and/or a content of the request and technical specifications of the communication channel.

A failure of the communicate command is a lack of response under pre-defined conditions. In other words, a response expected from the component, which is addressed by the communicate command, does not meet the pre-defined condition. The pre-defined condition can, for example, refer to a time limit, a voltage level, a signal quality, a checksum and/or a content of the response as for example a response including an error message. A failure of the communicate command can, for example, be caused by impaired or destroyed communication channels, either accidentally or on purpose.

A valid response to the communicate command received from the addressed component is the opposite of a failure. In other words: a response is valid if the pre-defined conditions of a failure are not met.

The fail operator, which is comprised by the policy language, defines handling of failures of the communicate command. The handling of failures of the communicate command can, for example, be an instruction to deny any access or to allow any access. The handling of failures of the communicate command can also be a more complex instruction and for example include one or more policies, fail operators and/or communicate commands.

As an example, the fail operator features as a predefined condition for a failure of the communication command a response time above five seconds. In other words, a failure of the communication command occurs following to the predefined conditions of the fail operator if a response of a component addressed by the communicate command does not occur within five seconds. If a failure occurs, i.e. no response is identified within five seconds after addressing the other component, the communicate command is terminated and the instructions defined by the failure operator are executed. In this example, upon failure of the communicate command and following to the instructions of the fail operator, another communicate command addresses another component of the distributed system with the same request (i.e. the request of the original command).

As another example, the fail operator features as a predefined condition for a failure of the communication command a response of a component addressed by the communicate command with a signal voltage below five volts and/or with a response time of more than two seconds after addressing the other component. If no such response is identified, a failure of the communicate command occurred, and the communicate command is terminated and the instructions defined by the fail operator are executed. In this example, upon a failure of the communicate command and following to the instructions of the fail operator, another communicate command addresses an internal memory of the PDP with the request of the original communicate command.

As yet another example, the fail operator includes instructions to generate a generic response to the communicate command after a failure to the communicate command occurred. By generating a generic response, the instructions of the fail operator result in a simulation of a response of the component which addressed by the communicate command. This generic response can for example be an instruction to deny any access or to allow any access. The generic response can also be a more complex instruction and for example include one or more policies, fail operators and/or communicate commands.

In an embodiment, the policy/policies are stored, defined in the policy language, in the PDP itself. The PDP in this embodiment may require a communication capacity to retrieve information on updates etc. of the policy/policies and/or information required to evaluate the policy/policies.

In another embodiment of the invention, the PDP retrieves every policy from one or more component of the distributed network by the communicate command. In other words, the PDP is not storing any policy and is requesting at each authorization process polices by executing a communicate command.

In still another embodiment of the invention, the PDP has stored one or more policies and is capable to additionally retrieve one or more further policies from one or more components of the distributed network by the communicate command. In other words, the PDP has stored a number of policies and is capable to additionally request a further number of polices by executing a communicate command. If the additional request of policies is needed can depend on the specific authorization process. In other words, depending on the authorization process, either the policies stored in the PDP are sufficient and no execution of the communicate command is needed, or additional polices are needed and therefore a communicate command is executed.

For example, one type of authorization where polices stored in the PDP are sufficient might be an authorization of a master key for a physical access control system. All PDPs grant access to the master key without need of additional policies. A type of authorization where polices stored in the PDP are not sufficient and a further number of polices is needed might be an authorization of a single entry ticket for a physical access control system, where the single entry ticket is invalidated after being used at one PDP of the physical access control system and therefore is to be denied authorization at any PDP (i.e. at the same PDP where it was used or at another PDP) of the physical access control system.

In all embodiments, the policies are defined in a policy language. The component storing a policy can store the policy in the policy language. The component storing a policy can store the policy in a compiled form, for example in form of one or more orders, commands or lists. The component storing policies can store the policies either only in the policy language, only in a compiled form, or in a mixture of policies in the policy language and policies in a compiled form.

The distributed system therefore includes a PDP, which is capable of executing an authorization process by communicating with other components of the distributed system i.e. by executing the communicate command. Furthermore, the PDP is capable to execute the authorization process with a correct and predefined result even when the communication with the addressed component fails (i.e. even when a failure of the communicate command occurs). Such a system is more reliable, stable and/or safe compared with state-of-the-art systems. The distributed system as described above is more resistant to attacks, failures and/or accidents compared to state-of-the-art systems. The distributed system as described above features the advantage of being fail-safe. The distributed system as described above can be faster than state-of-the-art systems, since a failure of a communication can be handled quickly and does not hinder, affect and/or slow down the functioning of the distributed system.

The distributed system can also be analyzed systematically in parts or as a whole, since a failure of a communication channel or a failure of a communicate command is handled systematically in a predetermined way and therefore in a predictable and foreseeable way. The distributed system is flexible, because a failure of a communicate command is handled with an appropriate response defined by the failure operator. The distributed system is fail-safe due to clearly defined handling of failures of the communicate command. Such a system is also called failure-aware. Furthermore, the distributed system is safe and resistant to malicious manipulation since even when communication fails between components, the distributed system always behaves in a predefined way.

As an optional feature of the invention, the policy language is a formal policy language. A formal policy language is a mathematically precise policy language. In other words: a formal policy language defines a policy as a mathematical object with a rigorous semantics. This means that a formal policy language is based in total on rigorous mathematics.

An advantage of a formal policy language is the possibility to test a behavior of a distributed system with a given set of policies expressed in the formal policy language by analyzing the set of policies in an analytical way instead of by testing it or applying simulations on it. A formal policy language allows analytical proof of which components grants and/or denies authorization for a specific constellation of the distributed system and/or which component grants and/or denies authorization for all possible constellations of the distributed system. A formal policy language therefore allows for mathematically correct analysis of a result of an authorization process under given polices expressed in the formal policy language.

It is for example possible to guarantee that specific results of an authorization process will not occur by analytically proving that this specific result is not possible in regard of the policies applied. As another advantage of a formal policy language, an algorithm can be used to answer a question regarding a result of an authorization process without using an implementation of the concrete access control system. For example, given a policy, a set of all authorized access requests can be computed and/or be compared with policies with respect to a second policy.

As an alternative, the policy language can also be an informal policy language and therefore not mathematically precisely defined.

As another optional feature, the PDP includes a firmware that is free of the one or more policies. The one or more policies are the policies based on which the PDP is capable of executing the authorization process.

In other words, the one or more policies are separate of the firmware of the PDP. Therefore, the firmware of the PDP does not include the one or more policies based on which the PDP is capable of executing the authorization process. The disadvantages of firmware including at least a part of the needed policies as described above can therefore at least partially be avoided.

An advantage of the firmware being free of the one or more policies is that the PDP including its firmware can be tested for correct functioning independently of the policy/policies. Components with firmware functioning correctly and executing policies correctly will continue functioning correctly when a policy/policies are changed. Tests of the components are therefore not needed anymore for testing the behavior of the entire distributed system with regard to a policy/policies. Components with its firmware can be tested separately from the policy/policies. Components with its firmware can also be tested before being installed on the spot. The policy/policies can also be tested separately from the tests of the PDP with regard to its firmware. The policy/policies can also be tested before being installed on the spot. The disadvantages of testing components and/or of distributed systems of the state as described above can therefore at least partially be avoided.

Adapting, modifying and/or updating a distributed system with PDP including a firmware free of the policy/policies is quick, easy and safe. The PDP with its firmware can stay unchanged, only the policy/policies have to be changed to adapt, modify and/or update the distributed system. The policy/policies are defined in the policy language and can be tested separately and before changes to the distributed system are effectuated. Also repairing, replacing or maintaining such a distributed system is quick, easy and safe.

As an alternative, the PDP includes a firmware and the PDP is capable of executing an authorization process based on one or more policies defined in a policy language, where the firmware includes at least partially the one or more policies.

As a further optional feature, the policy language include sa delegate command, which defines rules for delegation of rights by an authorized subject. The delegate command allows a delegating subject to delegate rights to a receiving subject, if the delegating subject is authorized to delegate rights.

Delegation is a way to give authorization rights to a receiving subject. The delegate command includes an identification of the delegating subject and of the receiving subject. This would for example be sufficient if a predefined right or set of rights is delegated (for example a single one-time access right, a standardized set of minimal rights or an exact copy of all rights of the delegating subject). Optionally, the delegate command includes information about the right or set of rights to be delegated.

An example of an execution of a delegation command is described for a physical access control system: subject A which is the delegating subject wants to delegate to subject B which is the receiving subject a right to be authorized by a door's lock, which is the PDP. In this example, to be authorized by a lock means to be granted authorization to open the lock. Subject A chooses a door and requests to open the door's lock. The lock's policies have a delegate command that includes the information that subject A delegates rights to subject B. The door verifies if subject A is authorized to delegate rights and if subject A is authorized to delegate the specific right. If subject A is authorized to do so, then subject B is granted the rights.

The delegate command enhances the flexibility of a distributed system. In particular, the delegate command simplifies the administration of access rights in the distributed system. Due to the delegate command, the distributed system can be easily and quickly adapted. Alternatively, the distributed system can feature a policy language without a delegate command.

Optionally, rights delegated by executing the delegate command are stored in decentralized storage means. This means that the distributed system is either free of a central storage for rights or that at least a part of rights is stored in a decentralized manner.

For example, rights delegated with the delegate command can be stored by the subjects themselves. The subjects can provide the delegate command to the PDP together with the request submitted to the PDP.

As another example, rights delegated with the delegate command can be stored only in PDPs which are affected by the rights.

Storing rights delegated by executing the delegate command in decentralized storage means features the advantage that the delegated rights do not have to be communicated to a centralized storage means. This reduces the amount of communication and reduces a needed minimal size of a centralized storage means if one exists. Such a distributed system is simple and efficient. Such a distributed system is also more resilient to communication failures than state-of-the-art systems because the amount of communication between the PDP and the centralized storage is minimized.

As an alternative, the distributed system is capable of storing rights delegated by executing the delegate command at least partially in a centralized storage means, and/or is capable of storing a copy of rights delegated by executing the delegate command at least partially in a centralized storage means.

In one embodiment, the distributed system is a logical access system. A logical access system controls access on a logical level. Logical level means an abstract level where rights to access or not are represented as logical values (yes or no). As an example, logical access systems are used in IT systems to grant access to components, groups of components and/or subcomponents of the IT system. Also control of access to information and/or to different levels of administration or user rights are examples for applications of logical access systems.

A simple example of a logical access system is a first computer in a network trying to access a file stored on a second computer in the same network, where a third computer in the same network acts as a PDP. The first computer requests access to the file by communicating with the PDP, and the PDP communicates according to its stored policies with the second computer in order to verify whether the first computer has a right to access the file or not. The access is then granted on logical level, which means that the right to access the file is the logical value of either yes or no. Such an access is granted on an abstract level and results in a virtual access, in other words in a non-physical access.

A logical access system can benefit from all advantages mentioned above. If the distributed system as described above is a logical access system, the logical access system can be realized in a simple, flexible and fail-safe way.

In a further embodiment, the distributed system is a physical access control system. A physical access control system controls physical access of subjects. A subject includes for example a person and/or an object.

In a physical access control system, rights to access or not result in a physical action. For example, a door lock either keeps its state (open or locked) or it changes its state temporarily or without time limit (from open to locked or vice versa) according to the rights of a subject.

The result of the physical action of the physical access control system can, for example, be based on physical parameter such as a defined electrical tension as a result from a component evaluating policies. The result of the physical action of the physical access control system can for example also be based on a logical value such as a logical value as a result from a logical access system. In the latter case, the distributed system is a combination of a logical access system with a physical access control system, where the physical access control system bases on the logical access system.

A physical access control system can benefit from all advantages mentioned above. If the distributed system as described above is a physical access control system, the physical access control system can be realized in a simple, flexible and fail-safe way.

Alternatively, a distributed system can be a combination of a logical access system with a physical access control system, where a number of access rights is represented as logical values and a number of access rights result in physical action in a physical access control system as described above.

As a further optional feature, a firmware of the PDP is able to interpret the policy language. If the PDP can interpret the policy language, the policies which are expressed in the policy language can be understood by the PDP directly. A translation or compilation of the policies is not necessary. As an advantage of a PDP being able to interpret the policy language, updating the PDP can be simple and fast. Alternatively, the PDP can be free of the ability to interpret the policy language.

If a PDP is able to interpret the policy language, then in a variant of the invention, the policy language is interpreted in the PDP at each authorization request. This way, the PDP always interprets the current policy or set of policies. Updating and testing a PDP is simple and fast by replacing the policy or set of policies. As an alternative, the PDP can interpret the policy language in a first step and save according instructions respectively rights in another form for execution through the PDP in a second step at an authorization request. The first and second steps are independent of each other and/or separated in time.

Optionally, the handling of failures of the communicate command defined by the fail operator includes another fail operator. In other words, an instruction of the fail operator which is to be followed in case of a failure of the communicate command includes itself a fail operator.

The handling of failures of a communicate command includes one or more policies defined by one fail operator. The policies defined by a fail operator can in turn include additional communicate commands and/or fail operators. The handling of a failure can therefore result in another failure, which is handled by a second fail operator defined in the policies of the first fail operator. This way, cascades of fail operators can be realized. The ability of a fail operator to handle a failure by applying another fail operator renders the policy language and a distributed system using such a policy language flexible and versatile. As an alternative, the fail operator excludes a fail operator as a way to handle a failure of the communicate command.

Another aspect of the invention is an analysis tool for analyzing a result of an authorization process in a Policy Decision Point (PDP), where the authorization process is based on one or more policies of a distributed system. The distributed system includes two or more components, where at least one of the components is a PDP. The PDP is capable of requesting information from another component of the distributed system, and the PDP is capable of executing an authorization process based on policies defined in a policy language. The policy language includes a communicate command, an execution of which causes the PDP to request information from another component in the distributed system. The policy language also includes a fail operator, which defines handling of failures of the communicate command. Furthermore, the analysis tool is able to provide an analytical proof for the result of the authorization process.

Defining a policy or a set of policies that represent correctly a specific expected behavior of the distributed (i.e. the intended behavior) system is nontrivial. In an ideal case, all possible failures, errors and extreme cases should be identified and been taken into account while defining a policy or a set of policies. The number of all possible failures and errors can be large to the extent that it renders the manual verification of the policies intractable. A verification whether the policy or a set of policies results in a behavior of the distributed system matches exactly an intended behavior of the system is therefore in most cases tedious and time consuming.

Policy analysis is a task of verifying the behavior of a policy or a set of policies in all failure contexts. Policy analysis helps defining a policy or a set of policies by better understanding the authorization process defined by the policy or the set of policies in terms of its results, i.e. grants and denies. One way to carry out a policy analysis of one of the distributed systems above is to use an analysis tool for verifying the results of an authorization process defined by a policy or a set of policies. The analysis tool accepts as input a policy or a set of policies and an analysis question, and outputs a Boolean result: yes if the analysis question is answered positively, and no otherwise.

An analysis tool systematically verifies all possible conditions of the distributed system, where the distributed system is following a specific policy or a specific set of policies. These conditions include the outcomes associated with the communicate commands defined by the policies. An analysis tool is therefore checking the distributed system for all possible values of all variables in the distributed system.

The verifying or checking can be carried out by systematically testing all possible conditions, for example by iterative testing of all possible conditions by a computer. In the case of a formal policy language, the verifying or checking can also be carried out by a mathematical technique, for example by using a computer program which makes use of algebra. A formal policy language allows application of a mathematical proof technique.

The verifying or checking can for example be carried out by a computer in an automated way. In another example, the verifying or checking is carried out by a computer in an assisted manner, which means that the computer interacts with a person.

An analysis question may, for instance, ask whether a policy always grants (or always denies) a given set of requests for a subset of all possible conditions. For example, to verify that a set of policies correctly defines a given intended authorization process, one can check if the policies always grant requests when certain communicate commands fail. This can be encoded as an analysis question, which is fed to the analysis tool together with the set of policies. The policies are declared correct if the analysis tool outputs a positive answer.

As another example, one can verify whether for a given set of possible conditions, the authorization process defined by a first policy is identical to the authorization process defined by a second policy.

Due to the fail operator, the distributed system as describe above is fail-safe and the result of a communicate command combined with a fail safe operator is well defined for all possible cases. This allows a systematical analysis of a policy or a set of policies and therefore allows application of an analysis tool.

An analysis tool is advantageous because the behavior of the analyzed distributed system can be verified and predicted. This helps to find weak points, errors, error sources, possible attack points and/or critical components and/or communication channels. An analysis tool can be used to enhance the distributed system. If the policy language is a formal policy language, the analysis tool can feature the ability to prove analytically a specific behavior of the distributed system.

Another aspect of the invention is a method to execute an authorization process in a Policy Decision Point (PDP), where the PDP is a component comprised by a distributed system. The distributed system includes two or more components, and the PDP is capable of executing an authorization process based on one or more policies defined in a policy language. The method includes following steps:

the PDP executes a communicate command which includes a fail operator, where the execution of the communicate command causes the PDP to request information from another component in the distributed system, and
in a first case, if the communicate command is executed without failure, the PDP executes the authorization process based the on one or more policies defined in the policy language and based on the information requested and received the other component of the distributed system, or,
in a second case, if the communicate command is executed with a failure, the PDP executes instructions defined in the fail operator and executes the authorization process based the on one or more policies defined in the policy language.

Advantages, disadvantages and optional features of the method are analogue to the corresponding features of the distributed system described above.

Another aspect of the invention is a computer program which can be loaded into a memory of a policy decision point (PDP). An execution of the computer program includes an execution of the method described above.

Another aspect of the invention is a data carrier, including a computer program as described above.

All optional features described above can be combined in any combination.

### BRIEF DESCRIPTION OF THE DRAWINGS

The subject matter of the invention will be explained in more detail in the following text with reference to exemplary embodiments which are illustrated in the attached drawings, in which:

FIG. 1 schematically shows a first distributed system according to the invention;

FIG. 2 shows a sequence diagram of a second distributed system according to the invention;

FIG. 3 shows a flow diagram of a policy analysis and correction process;

FIG. 4 shows a sequence diagram of a third distributed system according to the invention.

### DETAILED DESCRIPTION OF THE INVENTION

The reference symbols used in the drawings, and their meanings, are listed in summary form in the list of reference symbols. In principle, identical parts are provided with the same reference symbols in the figures.

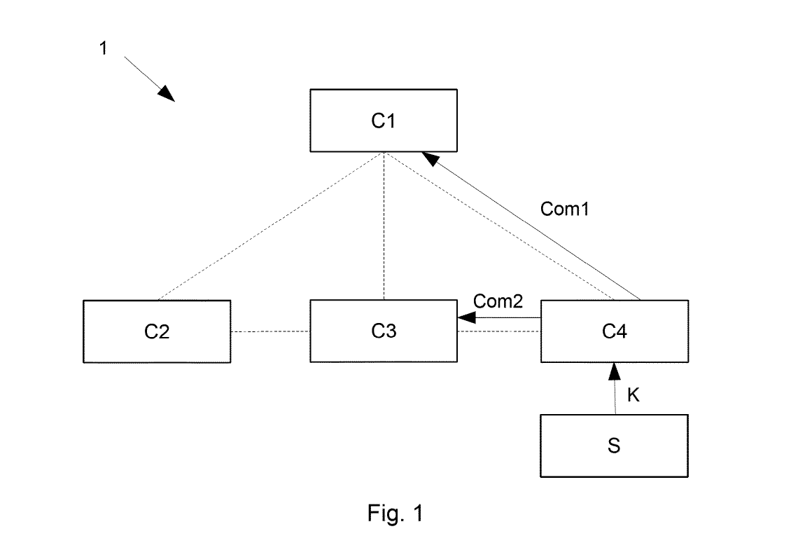

FIG. 1 schematically shows a distributed system 1 which is a physical access control system. The distributed system 1 includes four components C1-C4. In this example, all four components C1-C4 feature a memory which is capable to store policies. If policies are stored in the respective memories, then the policies are stored in a formal policy language. Communication between components means exchange between components and is represented in FIG. 1 as dashed lines between the four components C1-C4. Communication is in this context always a process in two ways: from one component to another and vice versa. The first component C1 features a central storage for policies, which are stored in a centralized way. The second, third and fourth component C2-C4 are PDPs including a door lock, electronic components and software, where the PDPs are capable of storing policies and capable of communicating with other components. The second, third and fourth component C2-C4 are PDPs that are locks in separate doors. All locks are in a locked state as default. Upon granted authorization by one of the PDPs C2-C4, the corresponding door lock will unlock and the door can be opened. If authorization is denied, the corresponding door lock remains in its default state, which is locked, and therefore the door can not be opened.

The first component C1 i.e. the central storage component C1 features a capability to communicate with all PDPs, which means with the second, third and fourth component C2-C4. All PDPs feature the ability to communicate between direct neighbors in FIG. 1 (besides the ability to communicate with the first component C1): the second component C2 is able to communicate with the third component C3, the third component C3 is able to communicate with the second component C2 and the fourth component C4, and the fourth component C4 is able to communicate with the third component C3.

When a subject S, in this case a visitor, wants to open the door that is controlled by the fourth component C4, then the visitor requests the fourth component C4 to execute an authorization process. This is done, for example by the visitor S presenting an electronic key K to the fourth PDP, i.e. to the fourth component C4. The fourth PDP C4 then executes the authorization process by executing a first communicate command Com1, which requests information about policies by addressing the central storage for policies in the first component C1. The first communicate command Com1 includes a fail operator.

In a first case, the first communicate command Com1 is executed without a failure. This means that the first component C1 is sending a response to the fourth PDP C4 which does not fulfill the pre-determined condition of the fail operator. In this example, a failure is defined as a response returning after 1500 Milliseconds after sending a request from the fourth PDP C4 to the first component C1. The pre-defined condition of the fail operator is therefore a response time of more than 1500 Milliseconds.

In this first case, the fourth PDP acts according to the response sent by the first component C1. This means that policies in the central storage for policies in the first component C1 are communicated to the fourth PDP C4 and that the fourth PDP C4 acts according to the polices. If the subject S has the right to open the door with the fourth PDP C4 as defined in the policies, then the fourth PDP C4 unlocks the lock of the door and subject S can open the door. If the subject S is not allowed to open the door controlled by fourth PDP C4 according to the policies, then the lock of the fourth PDP C4 remains locked and subject S can not open the door.

In a second case, the first communicate command Com1 is executed with a failure. This means that a response from the first component C1 to the fourth PDP C4 is returning with a delay larger than 1500 Milliseconds to sending the request from the fourth PDP C4 to the first component C1. In this second case, upon failure of the first communicate command Com1 and according to the instructions defined by the fail operator of the first communicate command Com1, a communicate command Com2 addresses the third component C3 with the same request as the communicate command Com1 (i.e. a request for information about policies). In the distributed system of FIG. 1, the third component C3 features a memory that stores the same policies as the central storage of the first component C1. The third component C3 acts as a backup for the first component C1. In this second case, the third component C3 replies to the communicate command Com2 and communicates a response with the needed policies to the fourth PDP C4. The fourth PDP C4 again acts according to the polices as described above.

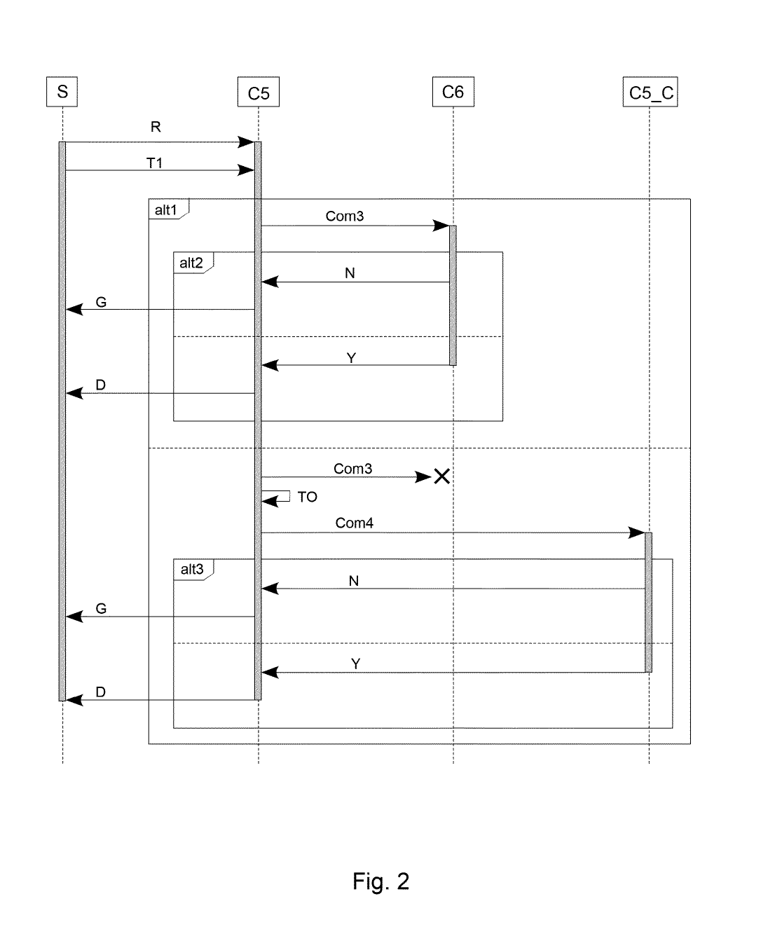

FIG. 2 shows a sequence diagram of a second distributed system according to the invention. This second distributed system is a physical access control system of a corporate building, which controls physical access to a corporate building. The second distributed system includes a PDP C5 and a Backend Server C6. The PDP C5 includes a memory storing a set of policies. The PDP C5 further includes a PDP Cache C5_C, which is a memory capable of storing revocation information. Revocation information is a set of data including revoked credentials. The Backend Server C6 also includes a memory capable of storing revocation information.

The PDP C5 is implemented in form of software and is stored in a door lock, which features according electronic elements. The PDP C5 is capable of interacting with the door lock in order to control the lock status of the door lock (open or closed). The PDP C5 is also capable of interacting with the door lock and in order to use communication channels of the door lock to communicate with the Backend Server C6.

In other words, access to the corporate building is controlled by the PDP C5 placed in the door lock. A person trying to access the corporate building is called a subject S. Whether a subject S is authorized or not, i.e. is allowed to access the corporate building or not, is defined in the set of polices stored in the PDP C5. The set of policies includes a policy which allows authorization of a subject S only in the case that a credential is presented by the subject S and under the condition that the credential is not revoked. A credential here is a digital key. A subject S can store its credential on access tokens such as phones and smartcards. To request access to the corporate building, a subject S submits the credential to the PDP C5 by interaction of the access token with the PDP C5. Here, the phone or smartcard interacts with the PDP C5 via near field communication (NFC).

Revoking a credential is, for example, necessary when dealing with lost or stolen access tokens. Also temporary locking of the building for specific subjects is a typical use case. If entry and exit of the corporate building are both controlled by the physical access control system, revocation of credentials for a subject S inside the corporate building (i.e. a subject that has already entered the corporate building without leaving the corporate building) can be used to prevent different subjects to access the corporate building by using the same credential.

The prevalent solution is to employ a backend server C6 to store revocation information. The PDP C5 must confirm that the credential provided by the subject S has not been revoked. The confirmation is carried out by execution of a communicate command Com3 addressing the backend server C6 with a request R and a credential T1 of the subject S trying to access the corporate building. The backend server C6 can however be unavailable due to lost network connectivity, server overloading, and so forth. This will lead to a failure of the communicate command Com3. In such cases, denying access to all credentials in case of an unavailable backend server C6 may be too restrictive. On the other hand, allowing access to all credentials T1 in case of an unavailable backend server C6 may be too permissive and therefore possibly too dangerous and risky.

The PDP C5 in FIG. 2 stores a copy of the revocation information of the most recent execution of a communicate command without failure in the PDP cache C5_C. If the query to the backend server C6 fails, i.e. if a failure of the communicate command Com3 occurs according to the pre-defined conditions of the fail operator, then the communicate command Com3 is terminated by executing instructions defined by the fail operator, and therefore another communicate command Com4 addresses the PDP cache C5_C instead of the backend server C6. This means that the communicate command Com3 from the PDP C5 addressing the backend server C6, which would retrieve an information whether the credential is revoked or not is terminated, and another communicate command Com4 addresses the PDP cache to retrieve the same information. This way, even when the backend server C6 is unavailable, authorization of subjects S is not too restrictive and not too dangerous. Since the backend server C6 is not available, working with the most recent backup is a good approach compared to treating all credentials T1 as revoked or treating all credentials T1 as not revoked.

The sequence diagram for the PDP C5 evaluating the set of policies, which are stored in the PDP C5 is given in FIG. 2. Subject S submits an access request, alongside the credential T1. The PDP C5 checks if T is revoked by executing the communicate command described above. The communicate command includes a fail operator. The communicate command first addresses the backend server C6 with a request to retrieve the information whether the credential is revoked or not.

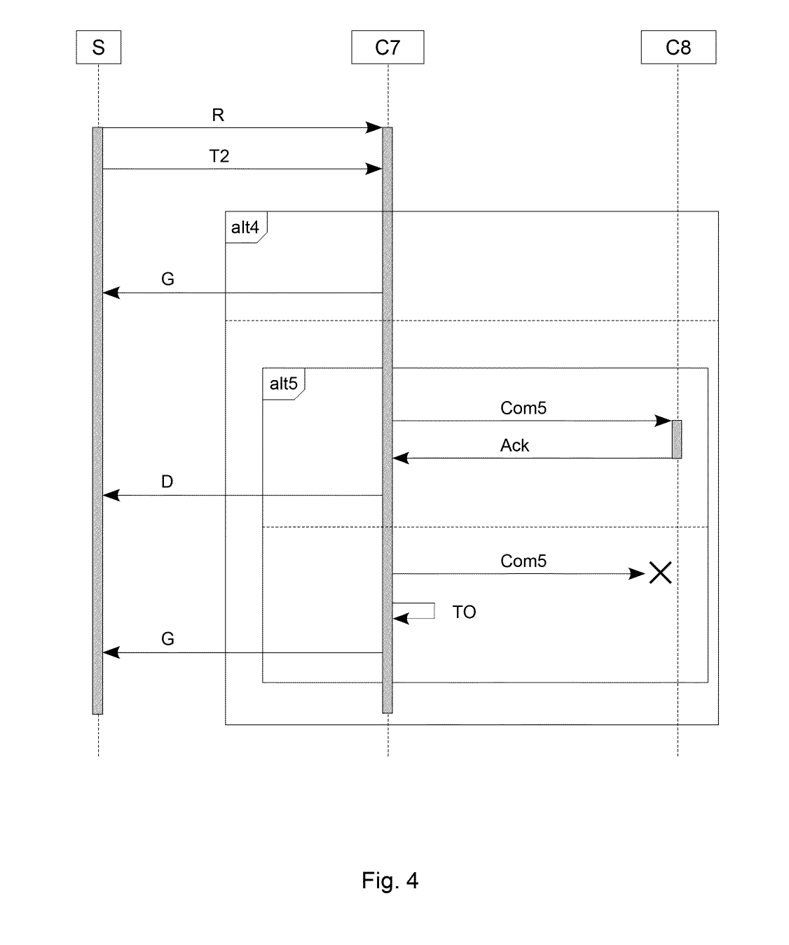

Alternative cases in FIG. 2 and FIG. 4 are schematically illustrated by a box surrounding both alternative cases. Both alternative cases are then separated by a dotted line. The box surrounding both alternative cases features on its left upper corner a reference sign from alt1 to alt5.

In a first case of first alternative cases alt1, the backend server C6 is up i.e. the backend server C6 is working. If the backend server C6 is up and the communication between PDP C5 and backend server C6 is functioning correctly, the communication command Com3 is executed without failure and the backend server C6 responds to the request of the PDP C5. In a first case of second alternative cases alt2, the PDP C5 grants access to the subject S (illustrated as an arrow with the reference sign G) if the credential T1 is not revoked (an according response is illustrated as an arrow with the reference sign N) in the backend server C6. In a second case of second alternative cases alt2, the PDP C5 denies access to the subject S (illustrated as an arrow with the reference sign D) if the credential T1 is revoked (an according response is illustrated as an arrow with the reference sign Y) in the backend server C6.

In a second case of first alternative cases alt1, the backend server C6 is down i.e. the backend server C6 is not working. In FIG. 2, this is illustrated by the communication command Com3 pointing towards a cross. The same scenario would also apply if the communication between PDP C5 and backend server C6 is not functioning correctly for other reasons, as for example communication channel impairment, manipulation or a power failure (the PDP C5 can feature an independent energy source as a battery for power failure safety). If the backend server C6 is down and the communication between PDP C5 and backend server C6 is not functioning correctly, the instructions defined in the fail operator are executed since the backend server C6 does not respond to the request of the PDP C6 within pre-defined conditions which represents a failure of the communicate command Com3. A failure of the communicate command C3 is in this example of FIG. 2 a timeout TO, i.e. the backend server C6 does not respond to the communication command C3 within a predefined time limit. Following to the instructions defined in the fail operator, another communication command Com4 is executed, and the other communication command Com4 addresses the PDP Cache C5_C instead of the backend server C6 with the request to retrieve the information whether the credential T1 is revoked or not.

Since the PDP Cache C5_C features a copy of the last successful execution of the communication command Com3, the PDP Cache C5_C can provide the requested information—but with the drawback that it is not the most recent information. Once the PDP C5 receives a response within execution of its communicate command Com4, the PDP C5 will continue to evaluate the set of policies, which results in alternative cases alt3 as shown in FIG. 2. This means that the PDP C5 grants access to subject S (illustrated as an arrow with the reference sign G) only if the credential T1 is not revoked in the PDP Cache C5_C, otherwise it denies (illustrated as an arrow with the reference sign D) access to subject S.

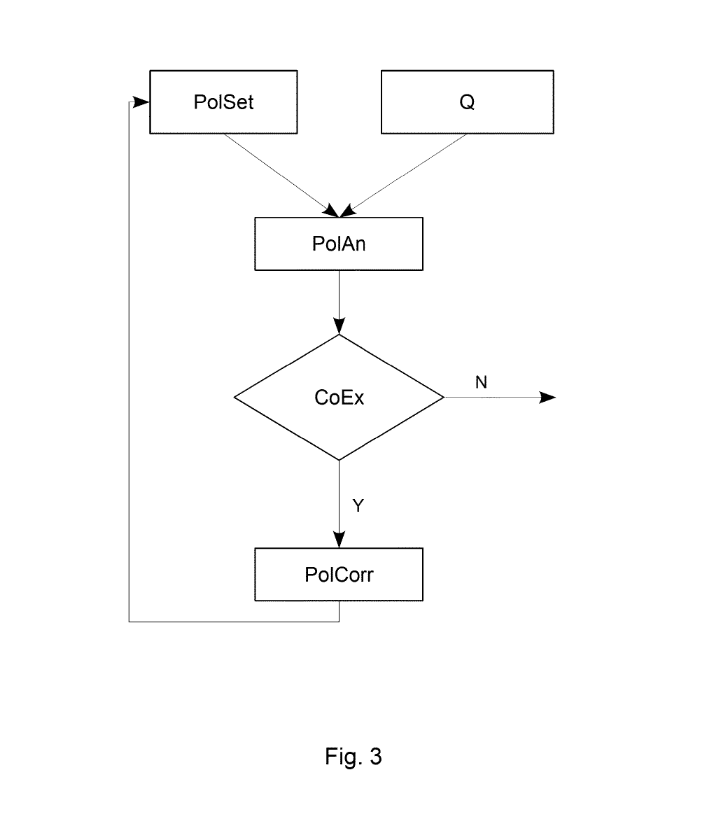

FIG. 3 shows a flow diagram of a policy analysis and correction process. A policy set PolSet including policies defined and expressed in the policy language is fed into a policy analysis tool PolAn. An analysis question Q is formulated and also fed into the policy analysis tool PolAn. The analysis question Q is formulated in a way such that the answer to this analysis question Q is of Boolean type and therefore either “yes” or “no”. The expected answer to the analysis question Q is set to be “yes”. The answer “no” is signalling that the policy set PolSet is not behaving as expected.

The policy analysis tool PolAn is analysis the analysis question Q in regard to the policy set PolSet in a systematic way (or in the case that the policy language is a formal policy language optionally in an analytical way) for counter-examples CoEx to the answer of the analysis question Q being “yes”. In order to do so, the policy analysis tool is searching for counter-examples CoEx to the answer “yes”, this means cases where the answer to the analysis question Q is “no”.

If the policy analysis tool PolAn does not find a counter-example CoEx to the analysis question Q being answered with “yes”, then the analysis revealed the expected result and the policy set PolSet works as expected (with regard to the analysis question Q). The analysis was therefore successful, and the analysis can be stopped. This is shown in FIG. 3 as an arrow N moving away from the symbol representing the counter-example CoEx.

If on the other hand the policy analysis tool PolAn does find a counter-example CoEx to the analysis question Q being answered with “yes”, then the analysis revealed an unexpected result. Therefore, the policy set PolSet does not work as expected (with regard to the analysis question Q). The analysis found a counter-example CoEx which is presented in all detail and can be used in a process step of policy correction PolCorr. The policy correction PolCorr is facilitated by the detailed description of the counter-example CoEx which was found by the policy analysis tool. Once the policy correction PolCorr is finished, the corresponding corrected policy set PolSet is fed to the policy analysis tool PolAn and the analysis starts again in a second iteration. This process can continue for as many iterations as are needed to find no counter-example CoEx to the analysis question Q being answered with “yes”. Finally, if all needed policy corrections CoEx are carried out, policy set PolSet shows the expected behaviour and the policy analysis and correction process can be stopped.

FIG. 4 shows a sequence diagram of a third distributed system according to the invention. Illustrations elements as arrows and reference signs of FIG. 4 are analogue to the ones in FIG. 2. The third distributed system is an IT access control system of a server that governs access to a web service. The third distributed system features a seventh component C7 and an eighth component C8. The seventh component C7 is a PDP and includes a memory for storing policies. The eighth component C8 is a ticket server, which is capable to issue a ticket T2 to a subject S, and also includes a memory for storing policies. The seventh component C7 and the eighth component C8 are capable of communicating with each other.

A ticket T2 issued by the eighth component C8 is valid for a given amount of time, i.e. a ticket T2 has an expiration date and time. A subject S requests access to the web service by submitting a request R to the seventh component C7 together with a ticket T2 obtained from the eighth component C8. The seventh component C7 grants access to the web service only if the subject S provides a valid ticket T2 for the request R. The ticket T2 is not valid after it has expired. When the ticket T2 expires, the subject S must request a new ticket from the ticket server (i.e. from the eighth component C8) in order to be able to access the web service. In this example the subject S, the seventh component C7 and the eighth component C8 communicate via the Internet Protocol which is a known state-of-the-art standard.

The advantage of the third distributed system is that the seventh component C7 is capable to grant a subject S access to the web service without explicitly knowing how to authorize subject S. Only the eighth component C8 must be able to authorize the subject S. In practice, the distributed system may contain additional components analogue to the seventh component C7, where the additional components govern access to additional web services. The additional components grant the subject S access to the additional web services if the subject S provides a valid ticket for these additional web services, where the according ticket is issued by the eighth component C8, i.e. the ticket server. The main drawback of the third distributed system is that no subject S can obtain a ticket if the eighth component C8 is unavailable. The eighth component C8 may take a long time to issue a ticket or the eighth component C8 may crash when a large number of subjects S request tickets.

Denying access to all subjects S whose tickets have expired may be too restrictive. This is because the subjects S may be unable to renew their tickets when the eighth component C8 is slow or unavailable. A more appropriate approach in some cases, e.g. when the availability of the web service is important, is to grant access to subjects S with expired tickets, provided the eighth component C8 is indeed unavailable. The more appropriate approach is realised by defining an appropriate policy including a fail operator for a communicate command Com5 between the first component C1 and the second component C2.

The sequence diagram for the seventh component C7 evaluating a request R made by a subject S is given in FIG. 4. Subject S submits an access request R together with a ticket T2. The seventh component C7 checks if the ticket T2 has expired. This results in two alternative cases alt4.

In a first case of alternative cases alt4, the ticket T2 has not expired and the seventh component C7 grants the subject S access to the web service.

In a second case of alternative cases alt4, the ticket T2 has expired. According to the policies stored in the seventh component C7, the seventh component C7 must check whether the eighth component C8 is unavailable. To this end, the seventh component C7 executes the communicate command Com5, which asks the eighth component C8 whether it is available. This results in two alternative cases alt5. If the eighth component C8 is available, the eighth component C8 sends a message Ack to the seventh component C7 (illustrated as an arrow with reference sign Ack). If the seventh component C7 receives the message Ack, then the seventh component C7 denies the subject S access to the web service, as defined by the policies stored in the seventh component C7: since the eighth component C8 is available and the ticket T2 has expired, subject S must request a new ticket from the ticket server (i.e. from the eighth component C8) and is therefore denied access with the expired ticket T2.

If the seventh component C7 does not receive the message Ack, for example due to a timeout TO, then the communication command Com5 has failed. As defined in a fail operator according to the policies stored in the seventh component C7, the seventh component C7 grants access to the subject S upon failure of the communication command Com5, because the eighth component C8 is indeed unavailable. Since the availability of the web service is important, and the eighth component C8 is not available for a request for a new ticket, the policies stored in the seventh component C7 include the fail operator which defines that in case of a failure of the communication command Com5, the seventh component C7 grants the subject S access to the web service.

While the invention has been described in present embodiments, it is distinctly understood that the invention is not limited thereto, but may be otherwise variously embodied and practised within the scope of the claims.

1. A distributed system comprising two or more components, where at least one of said components is a Policy Decision Point (PDP), where said PDP is capable of requesting information from another component of said distributed system, and where said PDP is capable of executing an authorization process based on one or more policies defined in a policy language, wherein
said policy language comprises a communicate command, an execution of which causes said to PDP to request information from another component in said distributed system, and
said policy language comprises a fail operator, which defines handling of failures of said communicate command.

2. The distributed system according to claim 1, wherein the policy language is a formal policy language.

3. The distributed system according to claim 1, wherein said PDP comprises a firmware and that said firmware is free of said one or more policies.

4. The distributed system according to claim 1, wherein the policy language comprises a delegate command which, defines rules for delegation of rights by an authorized subject.

5. The distributed system according to claim 4, wherein rights delegated by executing said delegate command are stored in decentralized storage means.

6. The distributed system according to claim 1, wherein the distributed system is a logical access system.

7. The distributed system according to claim 1, wherein the distributed system is a physical access control system.

8. The distributed system according to claim 1, wherein a firmware of said PDP is able to interpret said policy language.

9. The distributed system according to claim 8, wherein said policy language is interpreted in said PDP at each authorization request.

10. The distributed system according to claim 1, wherein the handling of failures of said communicate command defined by said fail operator comprises another fail operator.

11. A policy analysis tool for analyzing a result of an authorization process in a Policy Decision Point (PDP), where the authorization process is based on one or more policies which are applied to a distributed system, where said distributed system comprises two or more components, where at least one of said components is a PDP, where said PDP is capable of requesting information from another component of said distributed system, and where said PDP is capable of executing an authorization process based on policies defined in a policy language, wherein:
said policy language comprises a communicate command, an execution of which causes said PDP to request information from another command in said distributed system,
said policy language comprises a fail operator, which defines handling of failures of said communicate command, and
said analysis tool is able to provide an analytical proof for said result of said authorization process.

12. A method of executing an authorization process in a Policy Decision Point (PDP), especially in a distributed system according to any claim 1, where said PDP is a component comprised by a distributed system which comprises two or more components and where said PDP is capable of executing an authorization process based on one or more policies defined in a policy language, comprising following steps:
executing, by said PDP, a communicate command which comprises a fail operator, where the execution of the communicate command causes said PDP to request information from another component in said distributed system, and
in a first case, if said communicate command is executed without failure, executing, by said PDP, said authorization process based said on one or more policies defined in the policy language and based on the information requested and received the other component of said distributed system, or,
in a second case, if said communicate command is executed with a failure, executing, by said PDP, instructions defined in said fail operator and executing said authorization process based said on one or more policies defined in the policy language.

13. A computer program that can be loaded into a memory of a policy decision point (PDP), where an execution of said computer program comprises an execution of a method according to claim 12.

14. A data carrier, comprising a computer program according to claim 13.
